(19) United States
(12) Patent Application Publication
(10) Pub. No.: US 2010/0124345 A1
(43) Pub. Date: May 20, 2010

(54) NEAR FIELD SOUND REPRODUCTION METHOD WITH ENHANCED SPATIAL QUALITIES

(76) Inventor: Raymond E. Wiech, III, Orange, CA (US)

Correspondence Address: DONALD W. MEEKER, 924 EAST OCEAN FRONT, # E, NEWPORT BEACH, CA, 92661, US

(21) Appl. No.: 12/274,370

(22) Filed: Nov. 20, 2008

(51) Int. Cl. H04R 5/02

(52) U.S. Cl. 381/303

(57) ABSTRACT

Sound modules are positioned in proximity to the head of a listener for near field sound. Primary loudspeakers in the sound modules are directed away from a user or blocked by a baffle. No direct sound from the primary loudspeakers reaches the ears of the user. Indirect sound reaches the ears of the user for enhanced near field spatial sound quality. Enhanced depth stereophonic sound is produced by two such modules. Four near field sound modules, two adjacent to each ear produces a surround sound effect. Modulated secondary loudspeaker(s) in each module and secondary baffles positioned opposite the primary loudspeaker(s) enhance the near field spatial sound qualities.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to sound reproduction systems and particularly to a near field sound reproduction system which may be used either adjacent or attached to an article of furniture and which is highly beneficial when used in association with an article of furniture with an attached near field sound system comprising of between two and seven small loudspeaker modules mounted to or adjacent the head of a listener using a suitable mounting system with two sound modules mounted on each side of the head of a listener and spaced an equal distance from the ears of the listener and oriented and positioned such that sound transmissions from the sound modules do not reach the ears of the listener directly and are obscured from the ears of the listener so that only indirect sound reaches the ears of the listener either with primary loudspeaker(s) contained within the sound modules facing away from the ears of the listener and obscured from the ears of the listener by the sound module enclosure or facing toward the ears of a listener and obscured from the ears of the listener by a secondary baffle so that no sound reaches the ears of the listener directly from the primary loudspeaker(s); each sound module comprising an enclosure or primary baffle which contains at least one primary loudspeaker and may have a secondary reflecting baffle for obscuring the direct output of the primary loudspeaker(s) from the listener and/or maximizing the travel of indirect sound around the listener's head, and optional secondary loudspeakers may be added to the back of each sound module opposite the primary loudspeaker(s) and nearer the listener's ears and driven with a time delayed and/or phase inverted signal to further isolate the sound field from the sound modules and enhance the quality of the indirect sound field created by the obscured primary loudspeaker(s).

2. Description of Related Art Including Information Disclosed Under 37 CFR 1.97 and 1.98

It is well known and researched in the field of psychoacoustics that the human brain uses information from the timing of sound signals it receives to establish location and distance of sound sources. Due to the so-called Haas effect, the determination of a sound source's apparent location is dependent on a line-of-sight relationship between the ear and the sound source. Obstructions in the direct path between the listener and the sound source force sound waves created by the sound source to travel and disperse around the obstruction, causing a shift in the location of and/or distance to the sound source perceived by the listener. Under most circumstances in nature, the perceived shift in sound location is minor.

Polychannel sound reproduction systems typically exploit the Haas effect in the positioning and selection of sound reproduction devices (loudspeakers or other sound producing devices) to create controlled sound fields. These systems normally project sound directly toward the listener's ears for maximum fidelity, intensity, and sound field accuracy. What is novel in the case of the present invention is the use of indirect sound fields wherein line-of-sight transmission of sound from a sound source to the ear of a listener is impeded in such a way that the acoustic appearance of a much larger sound field is created than that which would normally be limited by the actual positioning of direct radiating sound reproduction devices.

In near field direct sound reproduction applications, the size of the sound field perceived by the listener is significantly reduced by the close proximity of the direct radiating sound reproduction devices to the listener's ear due to the Haas effect. In these applications, sound waves do not have sufficient interaction with the ambient environment and each other to create a rich sound field before reaching the listener's ears. These applications produce a direct sound field that appears contained between the sound reproduction devices and the listener, often times appearing to come from within the listener's head. Further, the close proximity of the direct sound reproduction devices makes direct sound intense and uncomfortable to listen to.

Prior art devices do not adequately address the problems of near field sound reproduction and prior art surround sound systems are normally utilized to reproduce theater-sized sound fields with direct sound reproduction approaches and are not suited for near field sound applications.

U.S. Pat. No. 4,124,249, issued Nov. 7, 1978 to Abbeloos, shows a sound transmitting system has a large speaker mounted in a chamber formed in an article of furniture under the thorax area of a person resting on the article of furniture. A pair of arcuate members are mounted on the article of furniture at the person's head and have four distinct loudspeaker chambers enclosed therein for directing multichannel or single channel sound into the ears of the person. Each semicircular arcuate portion has a pair of speakers separated by an internal bulkhead mounted in the chambers thereof.

U.S. Pat. No. 5,097,821, issued Mar. 24, 1992 to Eakin, describes a somatic musical exposure system for a person, preferably in recumbent position on substantially rigid supporting means. Music emanates from an air chamber in a sound housing spaced apart from the person-supporting means. A relatively fixed frame carries the person-supporting means and also the sound housing, at least the former and optionally the latter being resiliently mounted relative to the frame and thereby partly decoupled therefrom. Such resilient mounting is preferably provided by elastomeric means intervening between the frame and the means resiliently supported thereby and extending both lengthwise and widthwise. Strip-like resilient mounting means preferably extends both along peripheral edges of the person-supporting means and transversely thereof between its ends.

U.S. Patent Application #20050226449, published Oct. 13, 2005 by Young, claims a massage speaker unit comprising a portable sound and vibration transmission device, compatible with common audio producing means, designed to enhance the relaxation experienced by a massage therapy client through the use of an upward facing subwoofer and distal cylinders containing speaker drivers positioned to create a surround sound effect.

U.S. Patent Application #20060153399, published Jul. 13, 2006 by Davis, describes a method and apparatus using ambient sounds for a therapeutic effect. The method and apparatus comprises a method of recording natural sounds with a matched microphone array, recording the signal on a high resolution recording device including creating an audio bed, and playing back the recording on a tuned playback system. The method and apparatus is used to create or duplicate an ambient sound space for ambient therapy. The speakers may be mounted in the patient's room or can be integrated with various furnishings such as beds or end tables within a hospital room.

U.S. Patent Application #20070195964, published Aug. 23, 2007 by Yokota, is for an audio reproducing apparatus including the following elements: an output circuit operable to generate audio signals to be supplied to first and second speakers placed near the ears of a listener; and a detector operable to detect the presence of sound output from other speakers placed at positions further away from the listener than the first and second speakers. When it is determined that there is no sound output from the other speakers on the basis of a detection result obtained by the detector, the output circuit performs a control operation so that audio signals to be supplied to the other speakers are supplied to the first and second speakers.

U.S. Patent Application #20070183617, published Aug. 9, 2007 by Yokota et al, provides an audio reproducing system including a pair of speaker units, a mounting unit for mounting the pair of speaker units, without being attached to a baffle board, to the vicinity of a listener's ears in a manner such that sounds emitted from the front and back of a diaphragm of each speaker unit are mixed, and an audio signal output unit for virtual sound imaging an input audio signal and outputting the virtual sound imaged signal to the pair of speaker units in a manner such that the listener listens to a sound reproduced by the pair of speaker units feeling as if the sound is emitted from a different speaker device.

U.S. Pat. No. 6,607,499, issued Aug. 19, 2003 to Becher, shows a relaxation station for inducing user relaxation including a sleeve with a reclining surface attached to said frame for accommodating a limb of a user. The sleeve has a plurality of preferably pairs of massage grippers connected to and extending generally upward therefrom. These massage gripper pairs are elongated members projecting generally upward from the sleeve and the gripper pairs are capable of moving reciprocally between an open and a closed position to simulate finger manipulated massage. In a closed position, they cradle and contact the body or a portion thereof of a user. These massage gripper pairs having motive actuators for producing movement between said open and said closed positions, such as scissors extenders or flexible cables The massage gripper elongated members produce massage motions in at least one massage contact pad. The contact pads preferably have a temperature regulator and a dry hydrotherapy supply for enhancing the relaxation of a user and to simulate human massage.

U.S. Pat. No. 6,494,851, issued Dec. 17, 2002 to Becher, claims a relaxation station for inducing user relaxation including a couch having a frame and a reclining surface attached to said frame for accommodating a user in a reclining position. The frame has a plurality of preferably pairs of massage grippers connected to and extending generally upward therefrom. These massage gripper pairs are elongated members projecting generally upward from the frame and the gripper pairs are capable of moving reciprocally between an open and a closed position to simulate finger manipulated massage. In a closed position, they cradle and contact the body or a portion thereof of a user. These massage gripper pairs having motive actuators for producing movement between said open and said closed positions, such as scissors extenders or flexible cables The massage gripper elongated members produce massage motions in at least one massage contact pad. The contact pads preferably have a temperature regulator and a dry hydrotherapy supply for enhancing the relaxation of a user and to simulate human massage.

U.S. Pat. No. 6,027,463, issued Feb. 22, 2000 to Moriyasu, shows a system that interacts with a full spectrum of audio signals. The system contains, input process or band-pass discriminators, post processors including fixed or variable threshold detection, music beat pattern detectors, and beat enhancer to control vibrators. The post processor contains various syntheses of massage patterns, beat rhythm, dynamic non-linear signal operator, re-mapping of signal pass between detected band-passed signal to the output vibrator devices, combined with resynthesized vibrating action operates in concert with music or sound beat and rhythm. The system offers the user selectivity of vibrator modes to respond to easy listening, moderate or hard beating rock or jazz. The user beat pattern programmability allows it to customize the vibrator mood to be modified in tune with the user's mood and rhythm of the selected music.

U.S. Pat. No. 5,306,880, issued Mar. 9, 2004 to Douglas et al, provides a multisensory stimulation system and method of use. The system includes a housing articulate on a support so as to align a marked viewport with an individual. The housing defines a viewing chamber which is an extension of a reflective light and image optical system chamber which receives light and images from one or more video monitors or images projectors and, in some embodiments, from alternate sources such as black lights and strobe light devices. The system also includes an aromatic sensory component, tactile sensation devices, an audio input system, and audio delivery devices.

U.S. Pat. No. 2,821,191, issued Jan. 28, 1958 to Paii, describes a treating table which provides a pulsating device that includes controlled sound, light and electrical vibrations that are adapted to tone up physically both healthy and sick persons. The pulsating device is of a type where the pulsation is synchronized with a musical score, permitting the user to “feel” the music as it is played. The musical score controlling the pulsations may be played from either a built-in radio or a phonograph. The loudspeaker is not directly associated with the top surface of this treating table.

U.S. Pat. No. 3,880,152, issued Apr. 29, 1975 to Nohmura, provides a health promoting device. The device comprises a chair or a bed with speakers incorporated therein. The speakers are disposed against the inside surfaces of the seat and back of the chair, and the top surface of the bed, so that the openings of the speakers will be directed toward a human body resting therein.

U.S. Pat. No. 5,216,769, issued Jun. 8, 1993 to Eakin, claims a foldable bed with sound generating capabilities comprising: a lower assembly formed of a leg section and a body section, a linear hinge coupling the sections for movement between an open orientation and a closed orientation, the lower assembly also including foldable legs; an upper assembly formed of a leg component and a body component, the upper assembly having a fixed central extent with a separation line overhanging the hinge, the upper assembly also having a torso extent, a thigh extent, a calf extent; a first adjuster coupling the torso extent and the body section, a second adjuster coupling the thigh extent and the leg section, a third adjuster coupling the calf extent and the leg section; covering associated with the upper assembly including a cushioning pad overlying the upper surfaces of the upper assembly; and a sound generating device in both the torso extent and the calf extent with the central extent and thigh extent forming an acoustical barrier therebetween, each sound generating device including a speaker with a baffle supporting the speaker and aperture extending through the baffle tending to equalize the pressures in the spaces on opposite sides of the baffle.

U.S. Pat. No. 5,035,235, issued Jul. 30, 1991 to Chesky, discloses a music vibration table and a system used to control the table and analyze vibration distributions on the surface of the table are used for chronic and acute pain therapy.

U.S. Pat. No. 6,996,243, issued Feb. 7, 2006 to Welker, indicates a loudspeaker having a shaped sound field. The loudspeaker and method provide a driver of a loudspeaker that is movable parallel to an axis of movement through a center of the driver to produce sound waves. The driver is aligned with the driver plane orthogonal to the axis of movement. The driver plane is at a non-zero acute angle to a support plane. A reflector is mounted facing a diaphragm of the driver for reflecting sound waves from the driver. The reflector is configured relative to the driver such that reflected sound energy is greatest in a selected direction from a front of the reflector and the driver, and diminishes a progressively larger angle from the selected direction. The selected direction diverges from the driver plane.

U.S. Pat. No. 6,603,862, issued Aug. 5, 2003 to Betts, puts forth a spherical loudspeaker system which provides a spherically shaped housing or enclosure containing one or more drivers or speakers motors, and cooperatively mounting the housing in association with a uniquely constructed reflector, hence a spherical loudspeaker system is achieved which controls and shapes the ultimate acoustical waveform produced thereby. The loudspeaker system of the invention controls and distributes the acoustical energy of the driver and housing, while shaping the acoustical energy field into a true hemispherical pattern, within the system's power bandwidth. By employing the invention, the point of summation of the hemispherical pattern is approximately eight times the diameter of the reflector, thereby achieving the desired hemispherical polar coverage patterns.

U.S. Pat. No. 5,268,538, issued Dec. 7, 1993 to Queen, concerns a hemispherically wide-radiating-angle loudspeaker system having the ability to uniformly direct high-frequency as well as low-frequency. The acoustical centers of a low-frequency and a high-frequency driver are aligned in space to provide a common source of sound to be directed through a common sound-guiding structure. The high-frequency sound is guided by the formation of an acoustical horn between the spherical mounting structure of the low-frequency driver and the reflector generally employed in reflecting and diffracting low-frequency sounds. One side of the acoustical horn has an acoustic path length smaller than the other, forcing sound to further diffract upon passage from the horn.

U.S. Pat. No. 6,597,797, issued Jul. 22, 2003 to Betts, illustrates a spherical loudspeaker system with enhanced performance having a spherically shaped loudspeaker and/or closure containing one or more drivers or speaker motors, mounted in cooperative association with a uniquely constructed reflector, a loudspeaker system is achieved which controls and shapes the ultimate acoustical waveform produced thereby. The system of invention controls and distributes the acoustical energy of the driver, while shaping the acoustical energy field in a true hemispherical pattern, within the system's power bandwidth. By employing the invention, the point of summation of the hemispherical pattern is approximately eight times the diameter of the reflector, thereby achieving the desired hemispherical polar coverage patterns.

U.S. Pat. No. 5,451,726, issued Sep. 19, 1995 to Haugum, is for an omnidirectional speaker system including woofer and tweeter speakers mounted in a concave, curved upper housing fabricated of a relatively hard shell exterior and a foam interior, preferably plastic. Beneath the upper housing is a base, including a generally conical phase compensation plug which disperses the sound waves equally in all directions through a circumferential aperture between the upper housing and base. In a preferred embodiment, the cross-sectional shape of the upper housing is parabolic and the cross-sectional shape of the phase compensation plug is hyperbolic. A foam ring is attached to the exterior surface of the upper housing to prevent the formation of a sonic “hot spot” which can lead to a high intensity sonic beam objectionable to listeners.

U.S. Pat. No. 5,306,880, issued Apr. 26, 1994 to Coziar, provides an omnidirectional speaker system including woofer and tweeter speakers mounted in a concave, curved upper fabricated of a relatively hard shell exterior and a foam interior, preferably plastic. Beneath the upper housing is a base, including a generally conical phase compensation plug which disperses the sound waves equally in all directions through a circumferential aperture between the upper housing and base. In a preferred embodiment, the cross-sectional shape of the upper housing is parabolic and the cross-sectional shape of the phase compensation plug is hyperbolic.

The present invention solves these problems by shielding the listener from direct sound and relying on the indirect propagation of sound waves to create a rich near field sound environment.

### BRIEF SUMMARY OF THE INVENTION

An object of the present invention is to provide a near field sound reproduction system having sound modules with primary loudspeaker(s) facing away from a listener such that the primary loudspeaker(s) direct sound radiations are obscured from the listener by the sound module enclosure(s) AND/OR with primary loudspeaker(s) facing toward a listener with a secondary baffle positioned between the primary loudspeaker(s) and the listener such that the primary loudspeaker(s) direct sound radiations are obscured from the listener to produce an indirect polychannel sound field (stereophonic and/or surround sound) by having no sound transmitted directly from a primary loudspeaker to an ear of a listener.

In brief, in the system of the present invention sound module enclosures or primary baffles are positioned in proximity to the head of a listener but configured and/or oriented such that direct output of the primary loudspeaker(s) within each sound module is/are obscured from the ears of the listener either by being directed AWAY from the listener, AND/OR direct output of the primary loudspeaker(s) within each sound module is/are directed toward the listener but obscured from the listener's ears by a secondary baffle or baffles positioned in the sound path between the primary loudspeaker(s) and the listener's ears. Primary loudspeaker(s) direct output is obscured from the listener's ears in such a way that sound only reaches the listener's ears by traveling indirectly around the sound module enclosure or secondary baffle, creating a field of indirect sound around the listener's head. This serves to obscure the direct sound source from the listener which causes the listener to perceive a shift in the location of the sound source due to subtle Haas effect cues and maximizes the perception of a large sound field, which can be a stereophonic and/or other polychannel surround sound field.

Sound modules are usually small (typically less than 12″ in any dimension), and will contain at least 1 primary loudspeaker. Sound modules may contain at least 1 optional secondary loudspeaker for use in modulating the primary loudspeaker(s) sound through delayed phase cancellation, harmonic and/or amplitude amplification and/or attenuation, or other signal processing to further enhance the indirect sound field image for the listener created by the primary loudspeaker(s). Sound modules equipped with secondary loudspeaker(s) will normally have the secondary loudspeaker(s) oriented directly opposite the primary loudspeaker(s) within the sound module enclosure, but nearer the listener's ear than the primary loudspeaker(s), the primary goal of the orientation of the secondary loudspeaker(s) being selective phase cancellation and/or other acoustic modification of the sound field created by the primary loudspeaker(s). Other configurations may use multiple primary and/or secondary loudspeakers to achieve a wide variety of enrichments to the sound field.

Since direct sound in a near-field application is often intense and uncomfortable, the basis of the invention is to conceal direct sound sources the brain uses for Haas location cues and instead employ the use of indirect sound, thereby creating the effect of a much larger sound field which to the listener appears disconnected from and beyond the sound modules which produce it. The effect of the present invention is primarily a “near-field” phenomenon, making it ideal for situations where the position of the head and ears is somewhat controlled. Massage tables and chairs, pedicure chairs, dental and medical examination chairs, theater seating, video games and gaming chairs, automobile and aircraft seats, music therapy seats, and other articles of furniture are all examples of possible candidates.

The object of the invention is to create a ‘shaped’ indirect sound field adjacent and/or around the head of a listener that largely obscures direct sound sources from the listener. Various enhancements to the sound modules can be made to control the shape of the sound field, including module shaping, sizing, and/or positioning, in combination with loudspeaker type, quantity of loudspeakers, position of loudspeaker(s) within the sound module, use of various types of acoustic reflectors and/or acoustic lenses external to the module, and/or special processing of electro-acoustic signals that drive the loudspeaker(s).

When the voice coil of a loudspeaker receives an electrical impulse of positive electrical polarity, the electromechanical portion of the loudspeaker is normally configured to respond with an OUTWARD motion of the loudspeaker cone in response to create a sound wave. If a second loudspeaker is connected to that same electrical source, but with reverse electrical polarity, the second loudspeaker responds by moving INWARD. In this case, the first loudspeaker creates a positive pressure sound wave and the second loudspeaker creates a negative pressure sound wave. If you place these loudspeakers very close to each other, the sound pressure waves they create largely cancel each other out, causing the sound to be substantially attenuated.

Normally, this is an undesirable condition for sound reproduction because the very sound the loudspeakers are trying to create is partially destroyed by phase cancellation. In the case of the sound module of the present invention having a primary loudspeaker firing away from the ear and secondary loudspeaker firing toward the ear, a phase inverted connection such as the one described above would create a phase cancelled sound field which sounds very weak and muffled.

However, part of the present invention employs separate processing of the electroacoustic signal sent to the secondary loudspeaker(s), including a time delay in sending the signal to the secondary loudspeaker(s). This allows the sound wave from the primary loudspeaker(s) to work it's way back around the sound module enclosure toward the listener's ear before the secondary loudspeaker(s) broadcasts the phase inverted and/or time delayed sound wave. By varying the amount of delay between the time the primary loudspeaker(s) receives the primary signal and the secondary loudspeaker(s) does the perceived size and/or quality of the sound field can be controlled. Further processing of the sound character broadcast by the secondary loudspeaker(s), such as selective frequency and/or harmonic amplification and/or attenuation, can further enhance the character of the indirect sound field. In the application, the listener doesn't hear sound from the secondary loudspeaker(s)—rather a lack of it due to the attenuating interaction with the sound field created by the primary loudspeaker(s). In fact, hearing ANY discernable directional sound from the secondary loudspeaker(s) would provide the listener's brain with undesired sound sources for Haas effect cues and actually has a NEGATIVE effect on the basic invention.

The purpose of the optional secondary loudspeaker(s) within the sound module is therefore twofold: A) To maximize the quality and apparent size of the indirect sound field created by the primary loudspeaker(s) by broadcasting a delayed, phase inverted, and/or otherwise processed sound wave to attenuate the primary loudspeaker(s) sound field on a directional basis, while providing no discernable directional audio cues to the listener, and B) to enable the system to deliver a phase inverted version of any ambient sounds in the vicinity of the listener to the listener's ear (noise cancellation).

The use of sound modules with optional secondary loudspeaker(s) is an enhanced embodiment of the basic invention which would normally use sound modules with only primary loudspeaker(s) obscured from the listener's ears. The exact position of the secondary loudspeaker(s) within the sound module is not terribly important. Moving them to a more oblique angle with respect to the primary loudspeaker(s) would only mean the separate processing of the electrical signals sent to the secondary loudspeaker(s) would need to be adjusted slightly—the effect would be substantially the same.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a top plan diagrammatic view of the near field sound reproduction system with enhanced spatial qualities of the present invention using two sound modules in a stereophonic configuration with loudspeakers facing away from a listener to produce a stereophonic sound field with enhanced stereo depth, showing the direction of the sound transmission (arrows) away from the listener and the direct sound waves produced by the loudspeakers (darkened area) obscured by the sound module enclosure containing the loudspeakers so that the location of the sound from the actual loudspeakers is obscured and the sound appears to originate from a wide array of virtual loudspeakers (shown dashed):

FIG. 2 is a top plan diagrammatic view of the near field sound reproduction system with enhanced spatial qualities of the present invention using a single sound module with a secondary reflecting baffle in front of the primary loudspeaker which faces away from the listener, showing the direction of the sound (arrows) reflecting off of the secondary baffle and the sound waves produced with direct sound waves from the loudspeakers and on the other side of the secondary baffle (darkened area) attenuated by the sound module enclosure and secondary baffle while the intensity and quality of the sound perceived by the listener is enhanced by the reflected sound from the secondary baffle so that less sound escapes away and the field of the sound heard by the listener is enhanced and the sound appears to originate from at least two or an array of virtual loudspeakers (shown dashed):

FIG. 3 is a top plan diagrammatic view of the near field sound reproduction system with enhanced spatial qualities of the present invention using four sound modules in a quadraphonic configuration with loudspeakers positioned in close proximity to the listener and facing away from the listener to produce an indirect polychannel and/or surround sound field with enhanced depth, showing the direction of the sound (arrows) away from the listener and the sound waves produced with direct sound waves from the loudspeakers (darkened area) attenuated by the sound module enclosures containing the loudspeakers so that the location of the sound from the actual loudspeakers is obscured from the listener and the sound appears to originate from an array of virtual loudspeakers encircling the listener (shown dashed):

FIG. 4 is a top plan diagrammatic view of the near field sound reproduction system with enhanced spatial qualities of the present invention using a single sound module with a pair of loudspeakers offset at an angle from one another and facing away from a listener and a secondary reflecting baffle in front of the loudspeakers to produce an indirect stereophonic sound field with enhanced stereo depth, showing the direction of the sound (arrows) after bouncing off of the secondary baffle and the resulting sound waves produced with direct sound waves from the loudspeakers and on the other side of the secondary baffle (darkened area) attenuated by the sound module enclosure and secondary baffle while the intensity and quality of the indirect sound perceived by the listener is enhanced by the reflected sound from the secondary baffle so that less sound escapes away and the field of the sound heard by the listener is enhanced and the sound appears to originate from at least two or an array of virtual loudspeakers (shown dashed):

FIG. 5 is an elevational diagrammatic view of the near field sound reproduction system with enhanced spatial qualities of the present invention showing a stereophonic configuration, as shown in FIG. 8, with various elevations of sound modules relative to the listener's ear, typically within a 30 degree angle of the horizontal plane through the ear, a maximum of about 36 inches from the ears, with anywhere from a 30 to 180 degree separation angle between modules, as shown in FIG. 8;

FIG. 6 is an elevational diagrammatic view of the near field sound reproduction system with enhanced spatial qualities of the present invention showing a quadraphonic and/or surround sound configuration, as shown in FIG. 9, with various elevations of sound modules relative to the listener's ear, typically within a 30 degree angle of the horizontal plane through the ear, a maximum of about 36 inches from the ears, with anywhere from a 30 to 180 degree separation angle between sound modules, as shown in FIG. 9;

FIG. 7 is an elevational diagrammatic view of the near field sound reproduction system with enhanced spatial qualities of the present invention showing a six sound module configuration for polychannel and/or surround sound reproduction, as shown in FIGS. 18-21, with various elevations of the rear sound modules relative to the listener's ear, typically within a 30 degree angle of the horizontal plane through the ear, a maximum of about 36 inches from the ears, with anywhere from a 30 to 180 degree separation angle between modules, as shown in FIG. 9 and two pair of sound modules mounted in front of the ears of the listener;

FIG. 8 is a top plan diagrammatic view of the near field sound reproduction system with enhanced spatial qualities of the present invention showing a stereophonic configuration, as shown in FIG. 5, with various elevations of sound modules relative to the listener's ear, typically a maximum of about 36 inches from the ears, with anywhere from a 30 to 180 degree separation angle between modules;

FIG. 9 is a top plan diagrammatic view of the near field sound reproduction system with enhanced spatial qualities of the present invention showing a quadraphonic configuration, as shown in FIG. 6, with various elevations of sound modules relative to the listener's ear, typically a maximum of about 36 inches from the ears, with anywhere from a 30 to 180 degree separation angle between modules;

FIG. 10 is a perspective diagrammatic view of the near field sound reproduction system with enhanced spatial qualities of the present invention using four sound modules in a quadraphonic configuration with primary loudspeakers positioned in close proximity to the listener and facing away from the listener to produce a polychannel and/or surround sound field with enhanced depth, showing optional secondary loudspeakers configured to selectively cancel sound from the primary loudspeakers and optional secondary baffles opposite the primary loudspeakers to further enhance the depth of sound, and showing the present invention used with a face support for a massage table or chair;

FIG. 11 is an end elevational diagrammatic view of the near field sound reproduction system with enhanced spatial qualities of FIG. 10;

FIG. 12 is a side elevational diagrammatic view of the near field sound reproduction system with enhanced spatial qualities of FIG. 10;

FIG. 13 is a top plan diagrammatic view of the near field sound reproduction system with enhanced spatial qualities of FIG. 10;

FIG. 14 is a perspective diagrammatic view of the near field sound reproduction system with enhanced spatial qualities of the present invention using two sound modules in a stereophonic configuration with primary loudspeakers positioned in close proximity to the listener and facing away from the listener to produce stereophonic sound with enhanced depth, showing optional secondary loudspeakers configured to selectively cancel sound from the primary loudspeakers and optional secondary baffles opposite the primary loudspeakers to further enhance the depth of sound, and showing the present invention used with a face support for a massage table or chair;

FIG. 15 is an end elevational diagrammatic view of the near field sound reproduction system with enhanced spatial qualities of FIG. 14;

FIG. 16 is a side elevational diagrammatic view of the near field sound reproduction system with enhanced spatial qualities of FIG. 14;

FIG. 17 is a top plan diagrammatic view of the near field sound reproduction system with enhanced spatial qualities of FIG. 14;

FIG. 18 is a perspective diagrammatic view of the near field sound reproduction system with enhanced spatial qualities of the present invention using six sound modules with primary loudspeakers positioned in close proximity to the listener and facing away from the listener to produce a polychannel and/or surround sound field with enhanced depth, showing optional secondary loudspeakers of each sound module configured to selectively cancel sound from the primary loudspeakers and optional secondary baffles opposite the primary loudspeakers to further enhance the depth of sound, and showing the present invention used with a face support for a massage table or chair;

FIG. 19 is an end elevational diagrammatic view of the near field sound reproduction system with enhanced spatial qualities of FIG. 18;

FIG. 20 is a side elevational diagrammatic view of the near field sound reproduction system with enhanced spatial qualities of FIG. 18;

FIG. 21 is a top plan diagrammatic view of the near field sound reproduction system with enhanced spatial qualities of FIG. 18;

FIG. 22 is a perspective diagrammatic view of the near field sound reproduction system with enhanced spatial qualities of the present invention using four sound modules in a quadraphonic configuration with primary loudspeakers positioned in close proximity to the listener and facing away from the listener to produce polychannel and/or surround sound with enhanced depth, showing optional secondary baffles opposite the primary loudspeakers to further enhance the depth of sound, and showing the present invention used with a head rest for a chair, vehicle, gaming chair, or other uses;

FIG. 23 is a top plan diagrammatic view of the near field sound reproduction system with enhanced spatial qualities of FIG. 22;

FIG. 24 is a side elevational diagrammatic view of the near field sound reproduction system with enhanced spatial qualities of FIG. 22;

FIG. 25 is a front elevational diagrammatic view of the near field sound reproduction system with enhanced spatial qualities of FIG. 22;

FIG. 26 is a diagrammatic view of the near field sound reproduction system with enhanced spatial qualities of the present invention showing a block diagram for electrical/audio signal components of the near field sound system of the present invention showing the units which may be physically separate or incorporated into a single electronics package for a single loudspeaker in a sound module;

FIG. 27 is a diagrammatic view of the near field sound reproduction system with enhanced spatial qualities of the present invention showing a block diagram for electrical/audio signal components of the near field sound system of the present invention showing the units which may be physically separate or incorporated into a single electronics package for a primary loudspeaker and a secondary loudspeaker in a sound module;

FIG. 28 is a diagrammatic view of the near field sound reproduction system with enhanced spatial qualities of the present invention showing a block diagram for electrical/audio signal components of the near field sound system of the present invention showing the units which may be physically separate or incorporated into a single electronics package for a pair of sound modules each with a single primary loudspeaker;

FIG. 29 is a diagrammatic view of the near field sound reproduction system with enhanced spatial qualities of the present invention showing a block diagram for electrical/audio signal components of the near field sound system of the present invention showing the units which may be physically separate or incorporated into a single electronics package for a pair of sound modules with a primary loudspeaker and a secondary loudspeaker in each sound module;

FIG. 30 is a diagrammatic view of the near field sound reproduction system with enhanced spatial qualities of the present invention showing a block diagram for electrical/audio signal components of the near field sound system of the present invention showing the units which may be physically separate or incorporated into a single electronics package for a near field quadraphonic surround sound system with four sound modules having a primary loudspeaker and a secondary loudspeaker in each sound module;

FIG. 31 is a diagrammatic view of the near field sound reproduction system with enhanced spatial qualities of the present invention showing a block diagram for electrical/audio signal components of the near field sound system of the present invention showing the units which may be physically separate or incorporated into a single electronics package including loudspeaker module channels and surround sound channels and a subwoofer and subwoofer amplifier for a near field surround sound system with four sound modules having a primary loudspeaker and a secondary loudspeaker in each sound module;

FIG. 32 is a top plan diagrammatic view of the near field sound reproduction system with enhanced spatial qualities of the present invention using a single sound module with a secondary reflecting baffle in front of the primary loudspeaker which faces toward the listener, showing the direction of the sound (arrows) reflecting off of the secondary baffle and the sound waves produced with direct sound waves from the loudspeakers and on the listener side of the secondary baffle (darkened area) attenuated by the secondary baffle while the intensity and quality of the sound perceived by the listener is enhanced by the reflected sound from the secondary baffle so that the direct sound source is obscured from the listener and less sound escapes away and the field of indirect sound heard by the listener is enhanced and the sound appears to originate from at least two or an array of virtual loudspeakers (shown dashed.

### DETAILED DESCRIPTION OF THE INVENTION

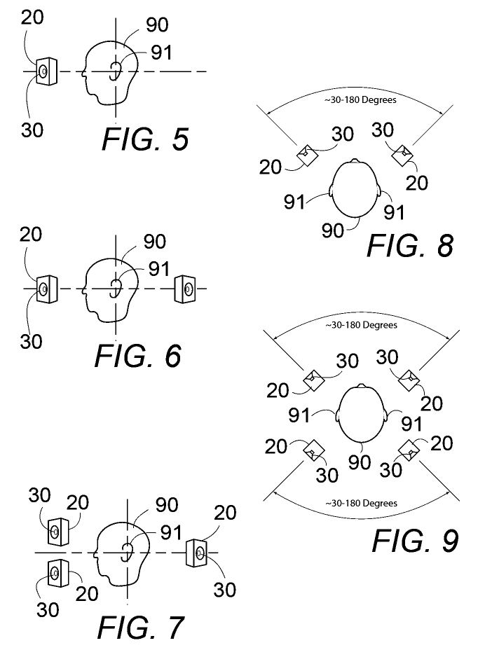

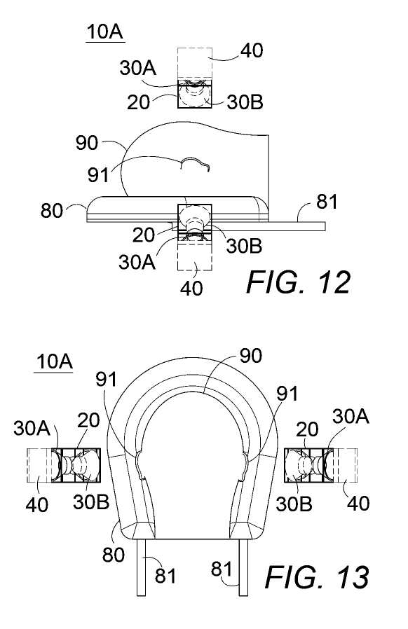

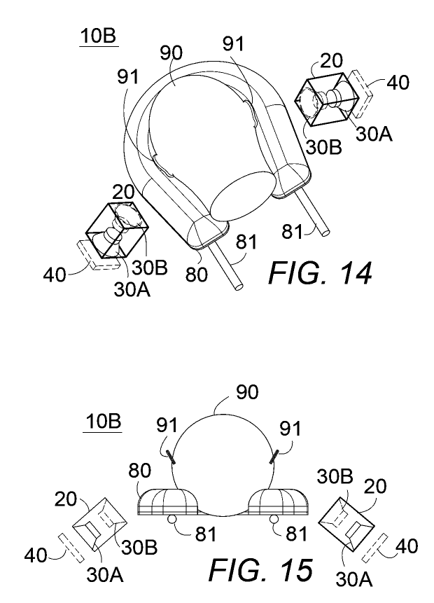

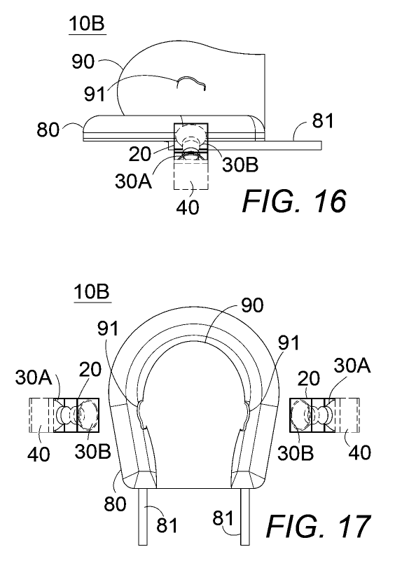

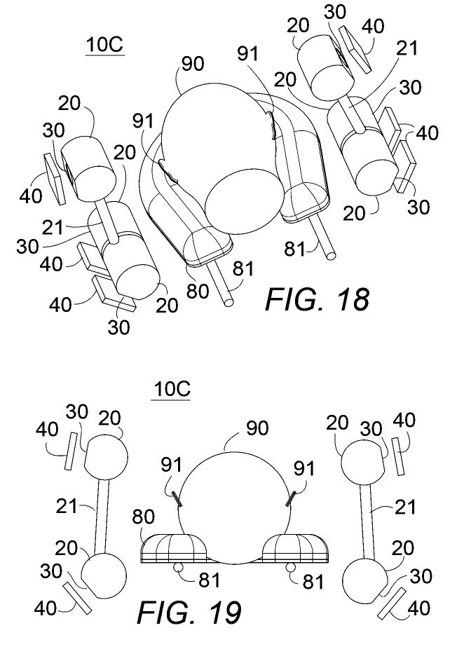

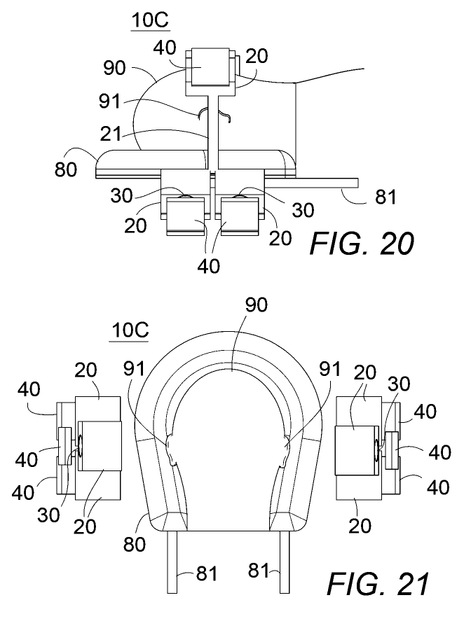

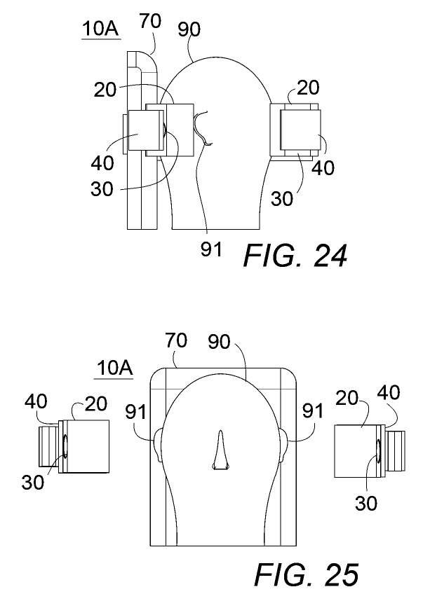

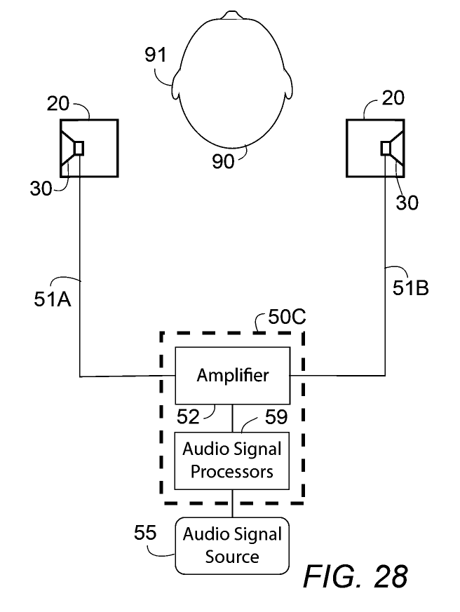

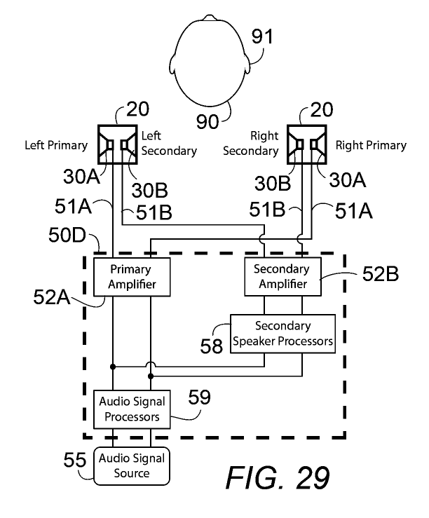

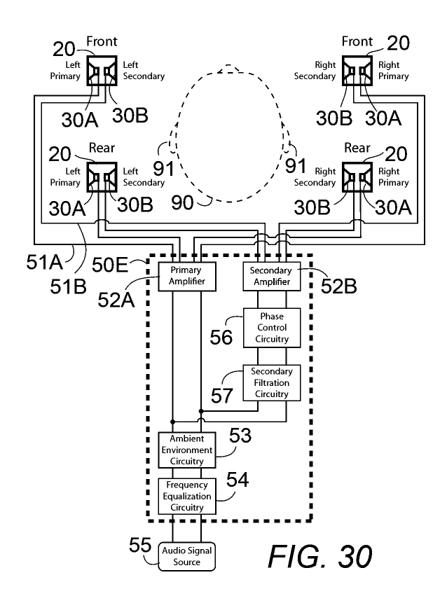

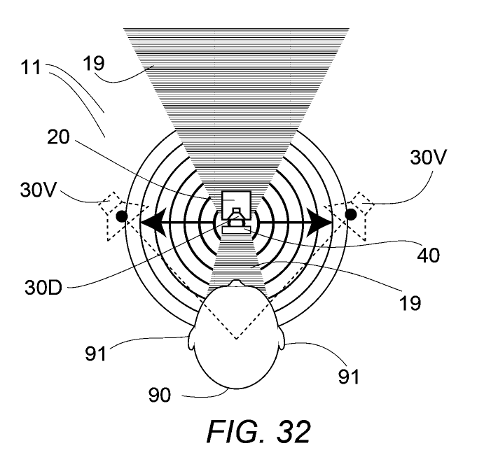

In FIGS. 1-32, a near field sound reproduction system 10 and 10A-10C with enhanced spatial qualities comprises sound modules 20 positioned in close proximity to the ears of a listener with the primary loudspeakers 30 and 30A facing away from the ears 91 of the listener 90 or a sound blocking baffle 40 placed between a listener and a loudspeaker 30 facing the listener, as in FIG. 32, so that no direct sound from the primary loudspeakers enters the ears of the listener and the listener experiences near field sound with enhanced spatial qualities including polychannel and/or surround sound and enhanced depth stereophonic sound.

Preferably, at least two sound modules 20 are positioned in proximity to the head 90 of a user with at least one sound module 20 positioned in proximity to each ear 91 of the user. The sound modules each comprise a primary loudspeaker 30 and 30A structured and positioned either pointing away from the listener and obscured from the listener's ears by the sound module enclosure as in FIGS. 1-31 or pointing toward the listener and obscured from the listener's ears by a secondary baffle as in FIG. 32 so that all sound produced by the primary loudspeaker is directed away from the ear of the user in the direction of the arrows, in FIGS. 1-4, the sound module enclosure 20 blocking direct sound created by the primary loudspeakers 30 as shown by the darkened area 19, and in FIG. 32 the secondary baffle 40 blocking direct sound created by the primary loudspeakers 30 as shown by the darkened area 19. The sound only reaches the ear of the user indirectly with no sound emitted directly from the primary loudspeaker 30 to the ear of the user so that sound only reaches listener's ears by traveling indirectly around the sound module enclosure or secondary baffle to obscure the direct sound source and create a field of indirect sound 11 around the listener's head and maximize the perception of a large sound field which is indicated by the virtual loudspeakers 30V showing the perceived location of the sound. In FIG. 3 with four sound modules 30 complete near field surround sound is achieved as indicated by the sound waves 11 and the virtual loudspeakers 30V surrounding the user.

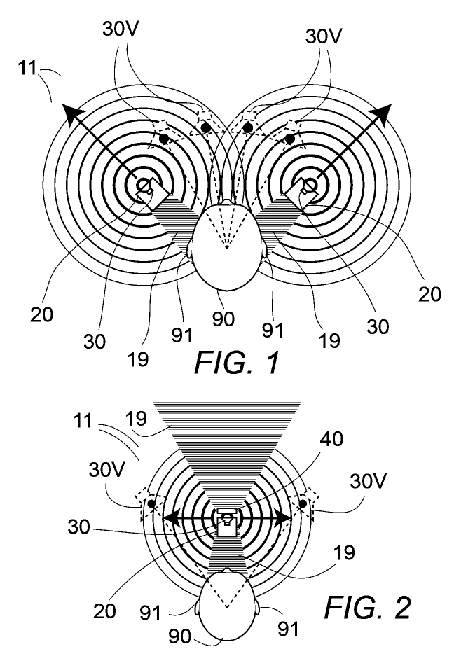

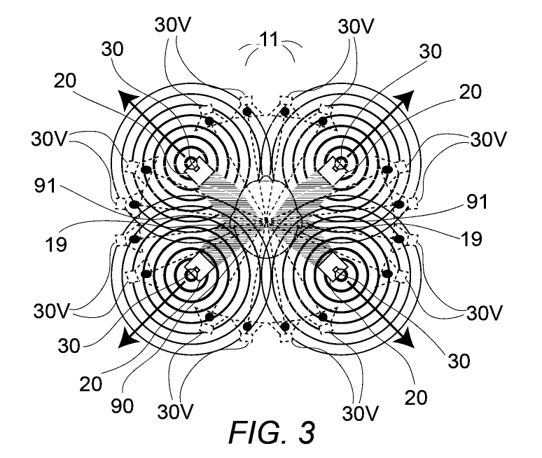

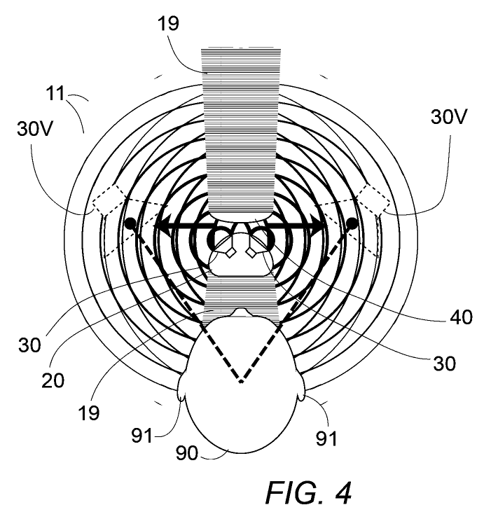

In FIGS. 2 and 4, each of the sound modules 20 may further comprise a secondary baffle 40 positioned in front of the primary loudspeaker(s) 30 and 30A to redirect sound energy (as shown by the arrows) from the primary loudspeaker(s) back into the indirect sound field 11, thereby reinforcing the indirect sound field to make the system and psychoacoustic effect less susceptible to the presence and position of objects in the vicinity of the sound modules and to minimize the amount of sound energy lost to the surrounding environment.

The secondary baffle 40 is positioned directly in front of and spaced apart from the primary loudspeaker(s) 30 and 30A and structured in a geometrical configuration that maximizes desired harmonic performance and lateral transmission of sound (arrows) while also obscuring the primary loudspeaker(s) to reinforce the indirect sound field while minimizing sound directly reflected toward the ears 91 of the user.

The secondary baffle 40 may be structured in a geometrical configuration taken from the list of geometrical configurations comprising flat (as shown in FIGS. 2, 11-25, and 32), parabolic, hyperbolical (as shown in FIG. 4), circular, angular, segmented or any other shape and position which deflects the sound waves into the sound field 11 but not directly at the ears 91 of the listener or user 90.

The system may comprise at least one secondary baffle 40 positioned in the vicinity of the primary loudspeaker(s) 30 and 30A and at least partially obscured from the ear of the user by the primary baffle or sound module enclosure so that sound reflected by the secondary baffle will not directly reach the listener's ear to maximize the intensity of the indirect sound field around the head of the listener while minimizing stray transmission of sound away from the listener. The secondary baffle would be positioned in the vicinity of the primary loudspeaker(s), and the secondary baffle shaped in a manner that would maximize the quality of the indirect sound field perceived by the listener.

In FIGS. 1, 5, 8, 14-17, and 29, the system comprises two sound modules 20 each with a single primary loudspeaker 30 and 30A, having one sound module adjacent to each ear 91 of the listener 90, and in FIG. 4, the system comprises one sound module having two primary loudspeakers 30, to produce an indirect stereophonic sound field around the head of the listener.

In FIGS. 3, 6, 9, 10-13, 22-25, 30, and 31, the system of claim 1 comprises four sound modules 20 having two sound modules adjacent to each ear 91 of the listener, one slightly in front of the ear and one slightly behind the ear, to produce an indirect quadraphonic and/or surround sound field around the head of the listener.

In FIGS. 7, and 18-21, the system comprises six sound modules 20 having two sound modules adjacent to and in front of each ear 91 of the listener 90 and one sound module adjacent to and behind each ear of the listener with the two sound modules in front of each ear connected to the same sound signal source such that the two sound modules in front of each ear behave as a single sound module to produce an indirect quadraphonic and/or surround sound field around the head of the listener.

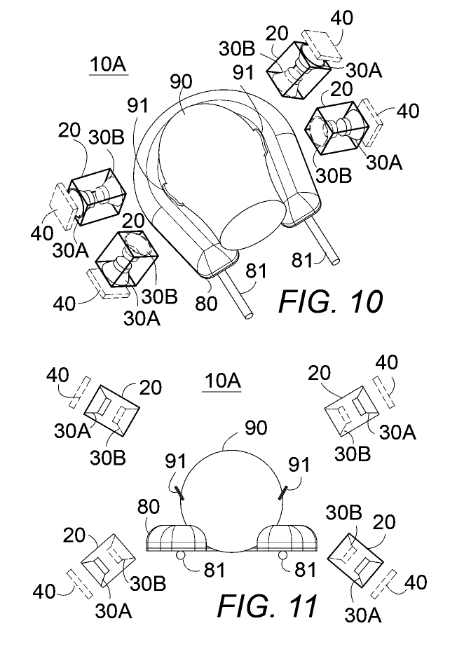

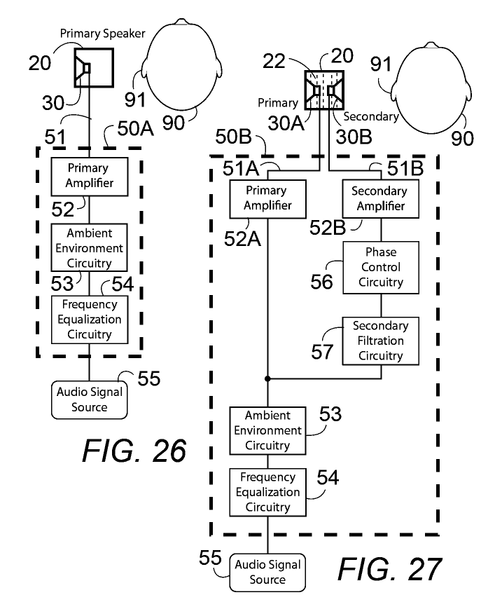

In FIGS. 10-17, 27, and 29-31, each of the sound modules may further comprise at least one secondary loudspeaker 30B and further comprise a modulating system, as shown in FIGS. 27 and 29-31, so that the secondary loudspeaker(s) modulates the primary loudspeaker(s) 30A sound field through at least one form of signal processing taken from a list of signal processing comprising delayed phase cancellation, harmonic amplification, harmonic attenuation, amplitude amplification, and amplitude attenuation to further enhance the indirect sound field image 11 of FIGS. 1-4 created by the primary loudspeaker(s) 30A. The primary loudspeaker(s) 30 and 30A may also have a sound modulating system as in FIGS. 26-31.

In FIGS. 26-31, the sound modulating system may include a primary amplification circuitry 52A, audio signal processing circuitry 59, secondary amplification circuitry 52B, ambient environmental control circuitry 53, frequency equalization circuitry 54, phase control circuitry 56, secondary filtration circuitry 57, secondary loudspeaker processing circuitry 58, center channel premix circuitry 49, subwoofer amplification circuitry 52C, all taking input from an audio signal source 55, which may be a stereophonic, polychannel, or surround sound audio signal source and transmitted through lines 51, 51A, and 51B to the loudspeakers 30, 30A, 30B and 30S.

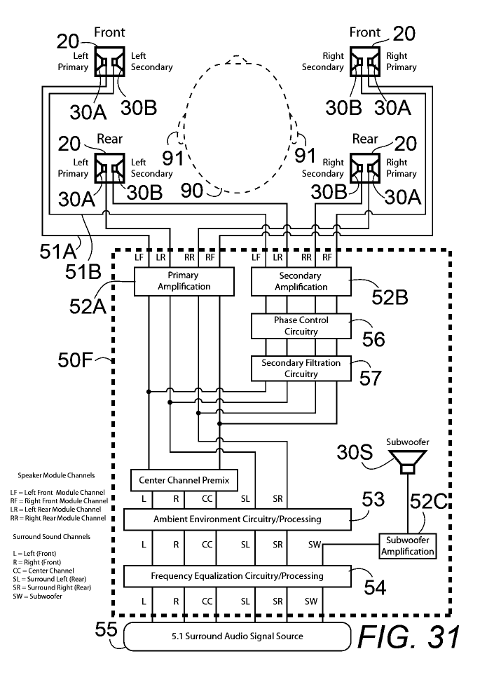

In FIG. 31, a block diagram for electrical/audio signal components of the near field sound system of the present invention shows the units which may be physically separate or incorporated into a single electronics package including loudspeaker module channels LF, RF, LR, and RR with amplification circuitry 52A and 52B, phase control circuitry 56 and secondary filtration circuitry 57 and surround sound channels L, R, CC, SL, SR, and SW with premix 58 ambient environment circuitry and processing 53, frequency equalization circuitry and processing 54; and a subwoofer 30S and subwoofer amplifier 52C for a near field surround sound system with four sound modules 20 having a primary loudspeaker 30A and a secondary loudspeaker 30B in each sound module, all producing a surround audio signal source 55.

In FIG. 32, a near field sound reproduction system with enhanced spatial qualities comprises an alternate embodiment of the sound module 20 positioned in close proximity to the ears of a listener with a primary loudspeaker 30D facing toward the ears 91 of the listener 90 and obscured from the ears of the listener by a sound baffle 40 so that no direct sound from the primary loudspeaker 30D enters the ears 91 of the listener 90 and the listener experiences near field sound with enhanced spatial qualities including polychannel and/or surround sound and enhanced depth stereophonic sound when the alternate embodiment direct facing speaker 30D and sound deflecting baffle 40 are used in any of the configurations and/or orientation of a speaker facing away as in FIGS. 1-31 still ensuring that direct sound transmission from the primary loudspeaker(s) is impeded and only indirect sound is heard by the listener, as indicated by the virtual speakers 30V which appear to the listener to be the source of the sound.

Each of the sound modules may further comprise at least one noise canceling microphone comprising at least one sound transducer and concomitant processing circuitry to include a phase inverted signal of ambient sounds in the transmissions of the secondary loudspeaker 30B for the purpose of minimizing or eliminating ambient sound perceived by the user.

Each of the sound modules may further comprise interior baffles 22, as shown in FIG. 27, so that intermodulation distortion between the primary loudspeaker(s) 30A and the secondary loudspeaker(s) 30B is affected to enhance the sound effect; either permitted, restricted to an extent that is beneficial to the sound module's acoustic performance, or prevented altogether.

Each of the loudspeakers 30, 30A, and 30B is preferably a small, full range loudspeaker having maximum frequency range potential to utilize the smallest loudspeaker possible to reproduce the best low frequency response possible while also being capable of full-range sound reproduction. Additional primary and/or secondary loudspeakers may be utilized to achieve the quality of indirect sound field desired, and primary and secondary loudspeakers do not necessarily need to be of the same type, size, and number to achieve the desired effect.

In FIGS. 10-21, each of the sound modules 20 is attached in proximity to a face rest or head rest 80 of a massage apparatus which may attach to the arms 81 connecting the head rest 80 to a massage table or massage chair.

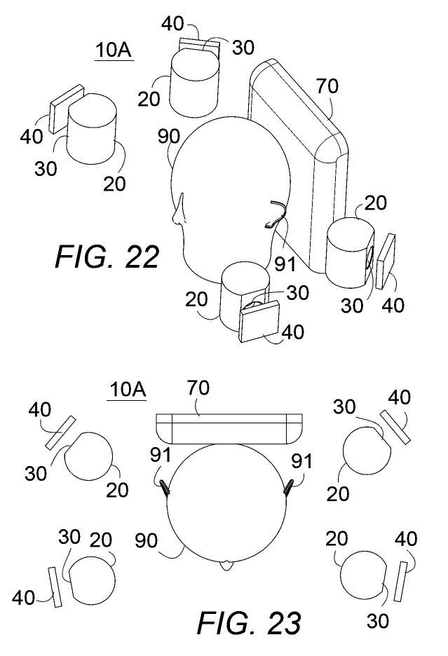

In FIGS. 22-25, each of the sound modules 20 may be mounted to a back of a head rest 70 which may be a head rest for a chair, vehicle, gaming chair, or other uses such as a head rest mounted to a video game for the purpose of immersing the user in a realistic sound environment or mounted to a multimedia presentation fixture for the purpose of immersing the user in a realistic sound environment.

Each of the sound modules 20 is preferably less than 12″ in any dimension.

Each of the sound module enclosures 20 may comprise sound absorbing material on the exterior surfaces to further isolate the apparent sound field from the sound module.

Each of the sound modules 20 may further comprise a tuned port configured in shape, size, and effective acoustic length to produce a phase inverted sound wave on the listener side of the sound module enclosure of sufficient amplitude and frequency character that would further isolate the apparent sound field created by the primary loudspeaker 30 and 30A from the sound module enclosure.

Each of the sound modules 20 may further comprise a passive radiator (loudspeaker without an electrical connection to any sound processing circuitry) configured in shape, size, and acoustic character to produce a phase inverted sound wave on the listener side of the sound module enclosure of sufficient amplitude and frequency character that would further isolate the apparent sound field created by the primary loudspeakers(s) 30 and 30A from the sound module enclosure.

The sound modules 20 are preferably positioned less than about 36″ away from the head 90 of the user supported by a frame 21 configured to substantially support the sound modules while exhibiting the lowest possible hindrance to the sound field.

In use, sound modules are positioned less than about 36″ away from listener's head, and are supported by a frame of either metallic, fiberglass, carbon fiber, wood, or other rigid material that can be configured to substantially support the sound modules while minimizing the transference of any vibration to the listener and exhibiting the lowest possible acoustic hindrance to the sound field, either by creating unwanted reflections or sound or by or substantially absorbing or blocking indirect sound created by the sound modules. This configuration can be in the form of a small diameter rod of sufficiently rigid material (metal, plastic, fiberglass, wood, etc.) featuring a solid cross-section, or a more acoustically transparent configuration (such as an aerodynamically shaped foil) of a larger cross-section of a less rigid material (such as fiberglass, plastic, or wood). To enhance the rigidity and esthetic appearance of the structure, the support members may be non-uniform in cross section, and may be incorporated into the structure of the sound modules. The support structure may also be of a honeycomb, cellular, or other non-solid configuration that would have the least hindrance on the sound field while still rigidly supporting the sound modules in their respective positions. To be part of the resonating chamber of the primary and/or secondary loudspeaker(s), the supporting structure may be composed of hollow members whose inner volume contributes to the overall resonating volume of the sound module enclosures, and may further serve as an extension of any bass-reflex configuration utilized in the construction of the sound enclosures by having their internal volumes vented to the outside sound environment at some point.

As an alternative mounting method specific to massage equipment, the sound modules could mounted into a device that would fit onto an existing face rest, or could be built into the face rest itself.

It is understood that a multitude of mounting systems can be employed to position the sound modules according to the specifications contained herein, including attachment to articles of furniture occupied by the listener, attachment to surfaces adjacent the listener and/or article of furniture, and/or attachment to a floor, wall, and/or ceiling, and that any variation in mounting systems employed can be application specific and shall not hinder the basis of the claims for the invention herein disclosed.

The modules can be driven with either single or multi-channel sound signals to achieve the desired acoustic effect.

The sound modules are wired in a manner that either allows them to be connected to a simple single or multi-channel audio source without any enhancement processing (primary loudspeaker(s) only), or in a manner that enhances the audio source driving the primary loudspeaker(s) and/or adds additional signal processing to drive the secondary loudspeaker(s) and further enhance the indirect sound field.

The source audio signals may be further processed using a delay line, frequency and/or harmonic amplification or attenuation, or other audio signal processing that will enhance the perception of a large and acoustically rich sound field.

The audio source may be a surround sound system capable of either 6 (5.1 channel) or 8 (7.1 channel) loudspeaker configuration, or a computer system (desktop or portable) capable of generating similar surround sound output, or other multi-channel audio signal source. For use with this invention, the center channel from either a 5.1 channel or 7.1 channel signal may be mixed back into the audio signals used to feed the 2 front sound modules, to present the listener with a phantom center channel sound module. The left center channel audio signal from a 7.1 channel signal format may be mixed back into the audio signals used to feed the 2 left sound modules to present the listener with a phantom left center channel, and the right center channel audio signal from a 7.1 channel signal format may be mixed back into the audio signals used to feed the 2 right sound modules to present the listener with a phantom right center channel. A separate subwoofer module may be used for low frequency enhancement, and may be placed anywhere within 10 feet of the listener's ears. For the most compact configuration, a subwoofer may be incorporated into a common structural element supporting all sound modules. For use without a subwoofer, the subwoofer signal may be mixed back into the audio signals used to feed all sound modules to present the listener with a phantom subwoofer channel.

The sound module system can be mounted to a massage table or chair for the purpose of immersing the client in a relaxing sound environment. The system can be mounted to a video game or other multimedia presentation fixture for the purpose of immersing the occupant in a realistic sound environment.

Exterior surfaces of the sound modules may be partially or completely covered in sound absorbing materials to further isolate the apparent sound field from the sound modules.

Sound modules may be equipped with a microphone or plurality of microphones other sound transducer, along with concomitant processing circuitry, to include a phase inverted signal of ambient sounds in the transmissions of the secondary loudspeaker(s) for the purpose of minimizing or eliminating undesired ambient sound perceived by the listener.

The interior configuration of the sound module may be open or baffled such that intermodulation distortion between the primary and secondary loudspeakers is either permitted, restricted to an extent that is beneficial to the sound module's acoustic performance, or prevented altogether. Baffles interior to the sound module may be rigid, but provided with a port to allow a certain amount of beneficial intermodulation between loudspeakers, or non-rigid.

All loudspeakers (primary and secondary) are small, full range type, having maximum frequency range potential. Object is to utilize the smallest loudspeaker possible to reproduce the best bass response possible while also being capable of full-range reproduction.

Between 2 and 7 sound modules may be used to create a desired effect. Normal usage would be 2 for a near field stereophonic sound field or 4 for a near field surround sound effect.

Sound modules may be equipped with a secondary reflecting baffle positioned in front of the primary loudspeaker(s) to maximize the amount of sound that is directed laterally around the enclosure to reinforce the field of indirect sound about the listener's head.

The main purpose of the secondary baffle or reflector is to impede direct sound transmission from the primary loudspeaker to the ear of the listener and/or to redirect sound from the primary loudspeaker(s) that would be lost to the surrounding environment laterally back around the sound module enclosure and into the indirect sound field in a manner that intensifies the indirect sound field while still obscuring the primary loudspeaker sound source, thereby reinforcing the indirect sound field and minimizing the amount of sound energy lost to the surrounding environment.

Secondary baffles or reflectors further make the system and psychoacoustic effect less susceptible to the presence and/or position of objects in the vicinity of the sound modules. Secondary baffles or reflectors can be of various shapes and sizes, and can be positioned anywhere up to 12 inches away from the primary loudspeaker(s) depending on the desired effect on the indirect sound field.

Secondary baffles or reflectors may be partially or completely coated in sound absorbing materials.

Secondary baffles may be flat or some other geometrical configuration (parabolic, hyperbolical, circular, angular, segmented, etc.) that maximizes harmonic performance and lateral transmission of sound to reinforce the indirect sound field while minimizing sound directly reflected toward the listener's ears.

Secondary baffles may either be partially or completely obscured from the listener by the primary baffle or sound module enclosure such that sound reflected by the secondary baffle will not directly reach the listener's ear, or are shaped in some other geometrical configuration (parabolic, hyperbolical, circular, angular, segmented, etc.) that will direct reflected sound back into the indirect sound field without being directed at the listener's ears. The intent of the secondary baffle or reflector is not to reflect sound directly back to the listener's ears, but to maximize the intensity of the indirect sound field around the listener's head while minimizing stray transmission of sound away from the listener.

In the system of the present invention sound module enclosures or primary baffles are positioned in proximity to the head of a listener but oriented such that the primary loudspeaker(s) are directed away from the listener, AND/OR output of primary loudspeaker(s) directed toward the listener is obscured from the listener's ears by a secondary baffle or baffles positioned in the sound path between the primary loudspeaker(s) and the listener. Primary loudspeaker(s) direct output is obscured from the listener's ears in such a way that sound only reaches the listener's ears by traveling indirectly around the sound module enclosure or secondary baffle, creating a field of indirect sound around the listener's head. This serves to obscure the direct sound source from the listener and maximize the perception of a large sound field.

Sound modules are small (less than 12″ in any dimension), and will contain at least 1 primary loudspeaker. Sound modules may also contain at least 1 secondary loudspeaker opposite the primary loudspeaker(s) but nearer the listener's ears for use in modulating the sound field created by the primary loudspeaker(s) through delayed phase cancellation, harmonic and/or amplitude amplification and/or attenuation, or other signal processing to further enhance the indirect sound field image for the listener created by the primary loudspeaker(s). Sound modules with primary loudspeaker(s) facing away from the listener may optionally contain 1 or more secondary loudspeaker(s) oriented directly opposite the primary loudspeaker(s), but nearer the listener's ear than the primary loudspeaker(s). Other configurations may use multiple primary and/or secondary loudspeakers to achieve a wide variety of enrichments to the indirect sound field.

The preceding descriptions are given merely by way of illustration and not in limitation of the invention and that various modifications may be made thereto without departing from the spirit of the invention as claimed.

What is claimed is:

1. A near field sound reproduction system with enhanced spatial qualities, the system comprising:
at least one sound module positioned in proximity to a head of a user, the at least one sound module comprising at least one primary loudspeaker structured and positioned in the at least one sound module so that all direct sound from the at least one primary loudspeaker is directed away from the head of the user and no direct sound passes from the at least one primary loudspeaker to the ears of the user, and only indirect sound reaches the ears of the user creating a field of indirect sound around the head of the user to obscure the source of the direct sound and maximize a perception in the ears of the user of a large sound field surrounding the head of the user.

2. The system of claim 1 wherein the at least one primary loudspeaker comprising at least one primary loudspeaker taken from the list of primary loudspeakers comprising a first primary loudspeaker structured and positioned in the at least one sound module pointing away from the head of the user so that all direct sound produced by the first primary loudspeaker is directed away from the ear of the user and a second primary loudspeaker structured and positioned in the at least one sound module pointing toward the head of the user, the second primary loudspeaker further comprising a sound baffle positioned between the second primary loudspeaker and the head of the user so that all direct sound produced by the second primary loudspeaker is directed away from the head of the user.

3. The system of claim 2 wherein each of the sound modules further comprises a secondary baffle positioned in the direct sound path of the at least one primary loudspeaker to redirect sound energy from the primary at least one loudspeaker back into the indirect sound field, thereby reinforcing the indirect sound field to make the system and psychoacoustic effect less susceptible to the presence and position of objects in the vicinity of the sound modules and to minimize the amount of sound energy lost to the surrounding environment.

4. The system of claim 3 wherein the secondary baffle is positioned and structured in a geometrical configuration that maximizes harmonic performance and lateral transmission of sound to reinforce the indirect sound field while minimizing sound directly reflected toward the ear of the user.

5. The system of claim 3 wherein the secondary baffle is shaped and structured in a geometrical configuration taken from the list of geometrical configurations comprising flat, parabolic, hyperbolical, circular, spherical, angular, splined, and segmented, that will reflect sound back into the indirect sound field in a controlled fashion without being directed at the ear of the user.

6. The system of claim 2 comprising two sound modules having one sound module adjacent to each ear of the user to produce an indirect stereophonic sound in the ears of the user.

7. The system of claim 2 comprising four sound modules having two sound modules adjacent to each ear of the user to produce a quadraphonic and surround sound in the ears of the user.

8. The system of claim 2 comprising six sound modules having two sound modules adjacent to and in front of each ear of the user and one sound module adjacent to and behind each ear of the user with the two sound modules in front of each ear connected to the same sound signal source so that the two sound modules in front of each ear behave as a single sound module to produce an indirect quadraphonic and surround sound in the ears of the user.

9. The system of claim 2 wherein each of the sound modules further comprises at least one secondary loudspeaker structured and positioned opposite the at least one primary loudspeaker and nearer the ear of the user than the at least one primary loudspeaker and further comprising a modulating system, the at least one secondary loudspeaker modulating the at least one primary loudspeaker sound through at least one form of signal processing taken from a list of signal processing comprising delayed phase cancellation, harmonic amplification, harmonic attenuation, amplitude amplification, and amplitude attenuation to further enhance the indirect sound field image created by the at least one primary loudspeaker.

10. The system of claim 9 wherein each of the sound modules further comprises at least one noise canceling microphone comprising at least one sound transducer and concomitant processing circuitry to include a phase inverted signal of ambient sounds in the transmissions of the at least one secondary loudspeaker for the purpose of minimizing or eliminating ambient sounds perceived by the user.

11. The system of claim 9 wherein each of the at least one sound modules further comprises interior baffles so that intermodulation distortion between the at least one primary loudspeaker and at least one secondary loudspeaker is effected to enhance the sound effect and to create at least one intermodulation distortion taken from the list of intermodulation distortions including permitting intermodulation distortion, restricting intermodulation distortion to an extent that is beneficial to the sound module's acoustic performance, and preventing intermodulation distortion.

12. The system of claim 2 wherein each of the loudspeakers is a small, full range loudspeaker having maximum frequency range potential to utilize the smallest loudspeaker possible to reproduce the broadest frequency response possible while also being capable of full-range sound reproduction.

13. The system of claim 2 wherein each of the sound modules is attached in proximity to a head rest of a massage apparatus.

14. The system of claim 2 wherein each of the sound modules is mounted in proximity to a video game and video game article of furniture for the purpose of immersing the user in a realistic sound environment.

15. The system of claim 2 wherein each of the sound modules is mounted in proximity to a multimedia presentation fixture for the purpose of immersing the user in a realistic sound environment.

16. The system of claim 2 wherein each of the sound modules is less than 12 inches in any dimension.

17. The system of claim 2 wherein exterior surfaces of each of the sound modules comprises sound absorbing material to further isolate the apparent sound field from the sound module.

18. The system of claim 2 wherein each of the sound modules further comprises a tuned port configured in shape, size, and effective acoustic length to produce a phase inverted sound wave on the user side of the sound module of sufficient amplitude and frequency character that would further enhance the indirect sound field and isolate the indirect sound field created by the at least one primary loudspeaker from an enclosure within the sound module.

19. The system of claim 2 wherein each of the sound modules is positioned less than 36 inches away from the head of the user supported by a mounting system configured to substantially support the sound modules, the mounting system configured to exhibit minimal hindrance to the sound field.
